(19) United States
(12) Patent Application Publication
(10) Pub. No.: US 2026/0350484 A1
(43) Pub. Date: Nov. 5, 2026

(54) METHOD FOR ESTIMATION OF DISTRIBUTION OF LARGE LANGUAGE MODEL (LLM) ENSEMBLE JUDGMENT

(71) Applicants: Honda Motor Co., Ltd., Tokyo (JP); Univ of North Carolina, Office of Sponsored Prog, Chapel Hill, NC (US)

(72) Inventors: Huaizhi Qu, Chapel Hill, NC (US); Sukwon Yun, Seoul (KR); Faizan Siddiqui, Santa Clara, CA (US); Kwonjoon Lee, Sunnyvale, CA (US); Tianlong Chen, Chapel Hill, NC (US)

(73) Assignees: Honda Motor Co., Ltd., Tokyo (JP); Univ of North Carolina, Office of Sponsored Prog, Chapel Hill, NC (US)

(21) Appl. No.: 19/451,228

(22) Filed: Jan. 16, 2026

Related U.S. Application Data
(60) Provisional application No. 63/778,056, filed on Mar. 26, 2025.

(51) Int. Cl. G06N 20/20

(52) U.S. Cl. CPC G06N 20/20

(57) ABSTRACT

A method for maximum a posteriori (MAP) estimations of large language model (LLM) ensemble judgment performance is provided. The method may model a judgement distribution as a mixture of beta-binomial distributions to reflect stratification. The method may use conformal prediction that enables adaptive stopping during iterative sampling when a sampling deviation is below a threshold value. The method may use a prior transfer mechanism that utilizes learned distributions on open-source datasets to improve estimation on a target dataset when only annotations below a threshold value are available.

### BACKGROUND

With the improving performance of large language models (LLMs), there may be a proliferation of adopting LLMs as judges for various tasks. In applications of LLM judge ensembles, the judgment distribution may be important to the service quality. Many datasets may be employed to evaluate the performance of LLM judges. However, these datasets rely on human annotations, which may be impractical at large scale due to the substantial time and financial costs of annotating. This challenge may highlight the need of how to estimate the LLM ensemble judging performance efficiently.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for maximum a posteriori (MAP) estimations of LLM ensemble judgment performance is provided. The method may model a judgement distribution as a mixture of beta-binomial distributions to reflect stratification. The method may use conformal prediction to enable adaptive stopping during iterative sampling when a sampling deviation is below a threshold value. The method may use a prior transfer mechanism that utilizes learned distributions on open-source datasets to improve estimation on a target dataset when only annotations below a threshold value are available.

According to an embodiment of the disclosure, a method for MAP estimations of LLM ensemble judgment performance is provided. The method may be implemented using a computer system including a processor communicatively coupled to a memory device. The method may model a judgement distribution as a mixture of two beta-binomial distributions, wherein a first beta-binomial distribution models a first set of LLM ensemble judgments on straightforward questions and a second beta-binomial distribution models a second set of LLM ensemble judgments for problems having at least one of multiple steps and multiple constraints. The method may optimize the mixture of the two beta-binomial distributions through expectation maximization. The method may use conformal prediction to enable adaptive stopping during iterative sampling when a sampling deviation is below a threshold value. The method may use a prior transfer mechanism that utilizes learned distributions on open-source datasets to improve estimation on a target dataset when only annotations below a threshold value are available.

According to an embodiment of the disclosure, a method for MAP estimations of LLM ensemble judgment performance is provided. The method may model a judgement distribution as a mixture of beta-binomial distributions. The method may optimize the mixture of beta-binomial distributions through expectation maximization. The method may use conformal prediction to enable adaptive stopping during iterative sampling when a sampling deviation is below a threshold value, wherein using conformal prediction dynamically evaluates the sampling deviation in a distribution of a number of correct judgments in the judgement distribution. The method may use a prior transfer mechanism that utilizes learned distributions on open-source datasets to improve estimation on a target dataset when only annotations below a threshold value are available.

### BRIEF DESCRIPTION OF THE DRAWINGS

FIG. 1 depicts an exemplary diagram of a method for MAP estimation of the distribution of LLM ensemble judgment in accordance with an embodiment of the disclosure;

FIG. 2 depicts an exemplary framework for MAP estimation of the distribution of LLM ensemble judgment in accordance with an embodiment of the disclosure;

FIGS. 3A-3D depict exemplary graphs comparing different judgment distributions in accordance with an embodiment of the disclosure;

FIGS. 4A-4D depict exemplary graphs showing different error rates in accordance with an embodiment of the disclosure;

FIGS. 5A-5D depict exemplary graphs of distribution prior transfers in accordance with an embodiment of the disclosure;

FIG. 6 is an exemplary graphs showing the actual number of samples under various thresholds (versus theoretical value in accordance with an embodiment of the disclosure; and

FIG. 7 depict exemplary graphs showing the actual number of samples from different datasets under three (values in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

Judgment distribution estimation may be defined as:

[symbol]

(# correct judgments=n|k LLMs judge sample x).

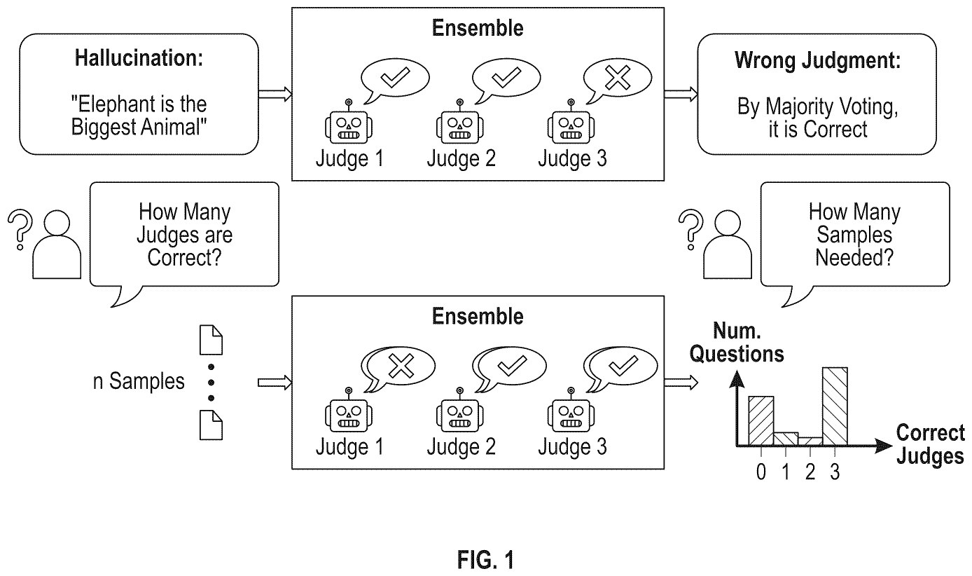

The present disclosure proposes an efficient method for MAP estimation of the distribution of LLM ensemble judgment to answer two research questions shown in FIG. 1.
1. RQ1: How to estimate the judgment distribution?
2. RQ2: How many samples are needed for estimation?

Given a small number of samples, one intuitive estimation may be to directly adopt the distribution of the samples as the judgment distribution on the entire dataset. However, this may be susceptible to the sampling bias. To avoid this, one common practice may be to first calculate the single LLM accuracy on the samples and then model the distribution on the full dataset as binomial. It may be first posited that the judgment distribution is not binomial. Theoretically, a binomial distribution may imply increasing accuracy in majority voting as the ensemble size grows. However, this may be unrealistic since the accuracy of LLM ensembles may remain bounded even with a large number of judges. To testify to this, the distribution of LLM ensemble judges on various benchmarks may be observed. Deviations from the binomial distribution may be marked and show a stratification between questions that can be classified as “easy” and “hard”. To this end, the judgment distribution may be modeled with a mixture of beta-binomial distributions to reflect the stratification. Under this assumption, it may be shown that by utilizing an expectation maximization (EM) estimation method, it may achieve accurate judgment distribution estimation with high data efficiency.

To guide the sampling process and determine how many samples to use for the estimation, the conformal prediction (CP) may be viewed as a way that may efficiently estimate the sampling deviation. Based on this, a novel adaptive stopping strategy for iterative sampling may be proposed, that may be designed to meet a pre-defined deviation threshold. Experiments may demonstrate the effectiveness of this method for limiting the sample amount while maintaining high estimation precision.

Moreover, it may be hypothesized that the prior knowledge of judgment distribution on open-source datasets may benefit the estimation of a new dataset when only a few samples may be available. To achieve this, a text similarity-based distribution prior transfer mechanism may be proposed. This method may embed text inputs from both source and target datasets and calculate embedding similarities to determine the transfer weight. The present design may improve the estimation accuracy when transferring from similar datasets and may avoid performance degradation when the datasets may be distinct. Notably, the present method may rely solely on the text inputs, which may make it practical for applications to vast amounts of unlabeled data.

The present method can be summarized as follows:
A novel work in judgment distribution estimation method. The binomial assumption of judgment distribution may be inaccurate, by replacing it with a mixture of beta-binomial distributions, efficient and accurate estimation may be achieved.
The method may use a rigorous conformal prediction-based adaptive stopping strategy during iterative sampling when the sampling deviation may be sufficiently low.
The method may introduce a distribution prior transfer mechanism that may leverage judgment distributions on open-source datasets to improve few-sample estimations,
Experiments may show BetaConform's high estimation efficiency. For example, using only 10 samples may result in an average of 10.84% error margin.

Reliable model evaluation may be a critical problem. Traditional human evaluations may remain the gold standard, but their scalability may be a significant bottleneck in large-scale applications. Thus, recent works may have proposed leveraging LLMs to evaluate the text quality, ranking outputs, and ensuring alignment with human preferences. While initially focused on text generation evaluation, the use of LLMs as judges has expanded to diverse applications which may include model alignment and security assessment, code quality evaluation, knowledge verification, and the like.

The reliability of such frameworks may have some concerns. Studies have found that even advanced models like GPT-4 may exhibit systematic biases such as position bias and egocentric bias, overconfidence in their judgments, and self-preference effects. Moreover, many studies employing LLM annotations may not explicitly measure the alignment between LLMs and humans, which may further raise questions about their dependability. While some have proposed various solutions, including dynamic evaluation pipelines, self-reflection mechanisms, and specialized benchmarks for assessing judge performance, these methods may fall short in offering rigorous guarantees of their outcomes.

Another direction of research may focus on providing statistical guarantees for LLM performance. Studies may have explored conformal methods to ensure correctness and factuality and to determine when LLMs should abstain from responding. While these methods may provide some statistical rigor, there may still be a need for a unified framework that may establish reliable, theoretically grounded approaches for assessing LLM performance across diverse applications.

The task of using an LLM ensemble to evaluate and judge samples by discerning, choosing, or scoring may be considered. Let:
n: Total number of samples in the dataset.
k: Number of LLMs in an ensemble.
S: The random variable of correct judgments.
r: Number of samples to estimate S.
D: A dataset to estimate the judgment distribution.

LLM Ensemble Judgment: Let [symbol] ={J₁, J₂, . . . , Jₖ} be an ensemble of k LLM judges. For a given input x, each LLM Jᵢ may generate an output oᵢ=Jᵢ (x), producing all judgments as [symbol] ={o₁, o₂, . . . , oₖ}. As may be shown below, the focus may be on binary and scoring judgment.

LLM Ensemble Correct Judgment: For an ensemble of k LLMs, the random variable:

$$S = {\sum }_{i = 1}^{k} Match ( {o}_{i} , y ) \qquad ( 1 )$$

may denote the number of correct judgments, where y may be the ground truth and Match(⋅) may be the criteria for correct judgment. The ensemble's decision may be correct if S≥└k/2┘. To avoid the situation of a tie when k is an even number and S≥└k/2∛, an odd number of k may only be considered.

Examination of Binomial Distribution: To start, examine the common assumption of S may follow a binomial distribution, i.e. the probability of having s correct judgments when a single judge accuracy \hat{p} is,

$${ℙ}_{Bin} ( S = s ) = Bin ( s \vert k , \hat{p} ) = ( \begin{matrix}k \\ s\end{matrix} ) \text{?} {( 1 - \hat{p} )}^{k - s} \qquad ( 2 )$$

The error rate [symbol] of ensemble judgment may be:

$${\tilde{P}}_{Bin} = {ℙ}_{Bin} ( S < ⌈ k / 2 ⌉ = {\sum }_{s = 0}^{⌈ k / 2 ⌉ - 1} ( \begin{matrix}k \\ s\end{matrix} ) {{\hat{p}}^{s} ( 1 - \hat{p} )}^{k - s} \qquad ( 3 )$$

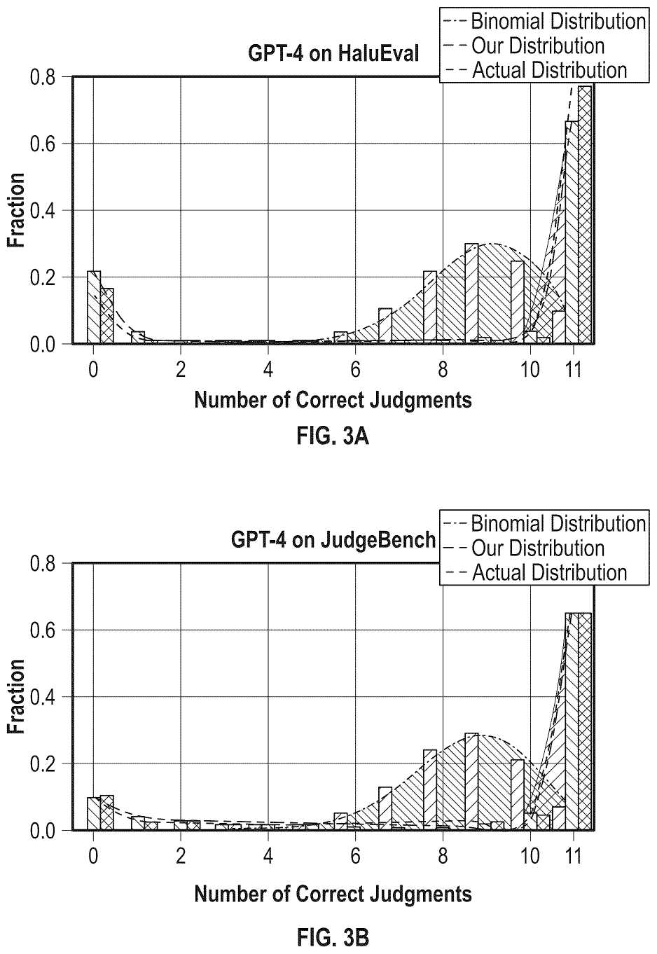

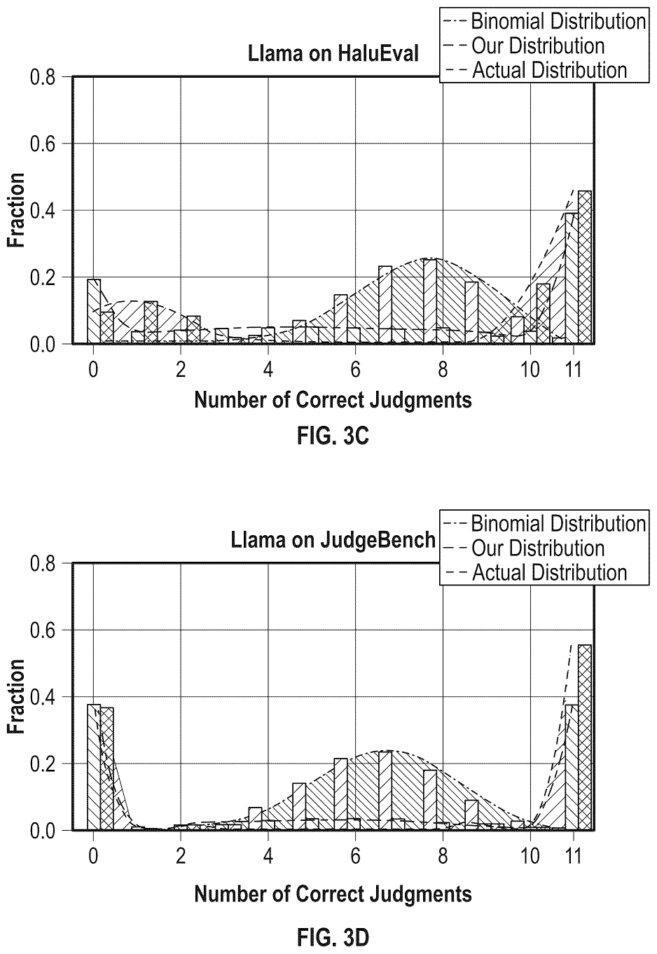

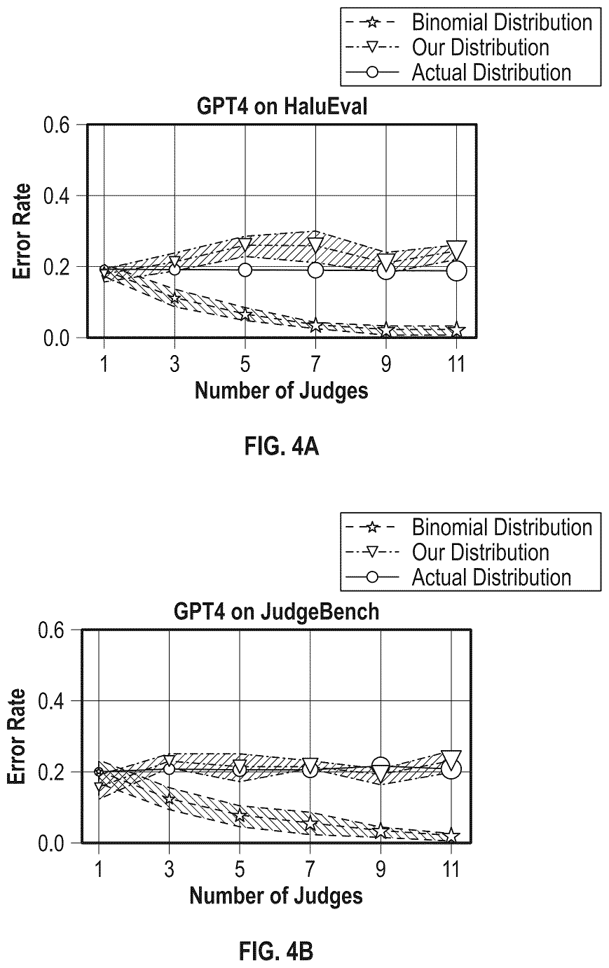

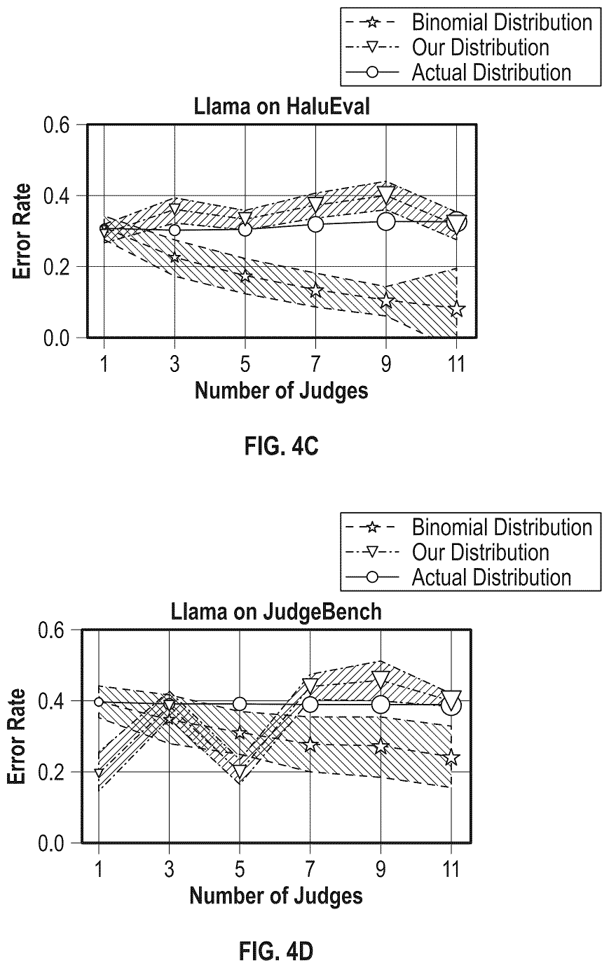

The common assumption that S follows a binomial distribution in Equation (2) may first be examined. Specifically, [symbol] evaluate individual LLMs on datasets across domains and [symbol] use the single LLM accuracy p in Equation (2) and (3) to estimate both the distribution of LLM ensembles on these datasets and the majority voting error rate for different numbers k of LLMs. Specifically, GPT-4 and Llama-3.3-70B may be evaluated on hallucination detection and Human alignment datasets. Results may be shown in FIG. 3 and FIG. 4.

The results in FIG. 3 and FIG. 4 may demonstrate the large deviation of binomial distribution to the real distribution. On both datasets, the real distributions of LLM ensemble judgments may consistently show two peaks centering at the two ends, while binomial distribution may result in a single peak with a large shift to either of the two peaks. Notably, in FIG. 4, the assumption of a binomial distribution may lead to an always decreasing majority voting error rate, which may be in contrast with the actual error rate that remains at the same level when the ensemble becomes larger.

S~ωBB(k,α₁,β₁)+(1−ω)BB(k,α₂,β₂) (4)

where BB(⋅, ⋅, ⋅) may be the beta-binomial distribution, k may be the number of judges in the ensemble, α₁, β₁, α₂, β₂ may be the parameters of the two distributions, and (a) may be the mixture weight.

The error rate of the mixture of beta-binomial distributions may be:

$${\tilde{P}}_{BB} = ω {\sum }_{s = 0}^{⌈ k / 2 ⌉ - 1} ( \begin{matrix}k \\ s\end{matrix} ) \frac{B ( s + {α}_{1} , k - s + {β}_{1} )}{B ( {α}_{1} , {β}_{1} )} + 1 - ω {\sum }_{s = 0}^{⌈ k / 2 ⌉ - 1} ( \begin{matrix}k \\ s\end{matrix} ) \frac{B ( s + {α}_{2} , k - s + {β}_{2} )}{B ( {α}_{2} , {β}_{2} )} \qquad ( 5 )$$

where B(⋅, ⋅) may be the beta function.

Examining the common binomial distribution assumption in FIG. 3 and FIG. 4, it may be noticed that the real distribution keeps showing two peaks centering near all wrong and all correct. Motivated by this observation, the distribution may be modeled as a mixture of two beta-binomial distributions, where one distribution models the LLM ensemble judgments on simple questions and the other one for hard problems. To derive all the parameters, labeled samples may be utilized from the dataset and design a distribution tailored expectation maximization (EM) algorithm.

Samples as Distribution Evidence: Given r samples, each containing judgments from k LLMs, Sᵢ may be the number of correct judgments in the i-th sample and pᵢ=Sᵢ/k may be the estimated probability of success for the i-th sample.

For the i-th sample, considering the first beta-binomial distribution, a responsibility

$${γ}_{1}^{i}$$

may be assigned to it:

$${γ}_{1}^{i} = \frac{wBeta ( {p}_{i} \vert {α}_{1} , {β}_{1} )}{wBeta ( {p}_{i} \vert {α}_{1} , {β}_{1} ) + ( 1 - w ) Beta ( {p}_{i} \vert {α}_{2} , {β}_{2} )} \qquad ( 6 )$$

where Beta(pᵢ|α,β) may be the probability density of beta distribution at pᵢ for the i-th sample under the corresponding beta component. γ₁ⁱ may represent the probability that the i-th sample may belong to the first beta component, and

$${γ}_{2}^{i} = 1 - {γ}_{1}^{i}$$

may be the probability for the second component.

Parameters Update: The parameters may be updated based on the weighted contributions of samples. The parameters of two distributions j={1, 2} may be updated as:

$${α}_{j}^{′} = {\sum }_{i = 1}^{r} {γ}_{1}^{i} \cdot {S}_{i} , {β}_{j}^{′} = {\sum }_{i = 1}^{r} {γ}_{1}^{i} \cdot ( k - {S}_{i} ) , {ω}^{′} = \frac{1}{r} {\sum }_{i = 1}^{r} {γ}_{1}^{i} \qquad ( 7 )$$

The present distribution assumption may be verified by first sampling r=100 judgments made by two models on two datasets and apply the present distribution-tailored EM algorithm to estimate the parameters. The present method may be evaluated in two scenarios: [symbol] In FIG. 3, fix the ensemble size k=11 and compare the estimated distribution against the real distribution and binomial distribution, and [symbol] in FIG. 4 estimate the error rate of majority voting with different ensemble sizes.

In FIG. 3, the mixture of beta-binomial distributions may be closer to the real distribution compared to the binomial, with clear two-peak patterns that may be analogous to the observation. In FIG. 4, it may show that the preset distribution may be consistently close to the real majority voting error rate across all ensemble sizes. Contrary to the binomial distribution that produced a decreasing error rate, the present distribution may successfully model the stable error rate when the ensemble becomes larger. Additionally, the narrow confidence interval may demonstrate the high stability of the present method.

In the experiments above, a fixed number of samples may be used. However, in practical settings where datasets may be unannotated and being labeled, it may be important to determine when the number of annotated samples may be sufficient for accurate estimation. Inspired by conformal prediction (CP), which does not rely on prior knowledge of the dataset distribution and may rigorously estimate the sampling deviation, leveraging its principles to address this challenge may be used.

Conformal Prediction for Adaptive Stopping: CP may provide a principled approach to dynamically evaluate the sampling deviation in the distribution of the number of correct judgments S, which may be used as guidance.

Nonconformity Scores: A major part of CP is the nonconformity score, which may measure how a test sample differs from the rest of the data. In our implementation, the nonconformity score may be set as:

score(Sᵢ)=|Sᵢ− [symbol] [S]| (8)

which may quantify the deviation of each observed value of S from the expected value.

Calibration Data and Quantile Computation: Suppose r samples have been used to test the LLM ensemble with S₁, S₂, . . . , Sᵣ correct judgments, the CP sampling may compute the nonconformity scores for all calibration data as sᵢ=score (Sᵢ) and these scores may be sorted in ascending order as s₁< . . . <sᵣ. For a desired estimation confidence 1−ϵ, the (1−ϵ)-quantile with r samples

$${q}_{1 - ϵ}^{r}$$

may be:

$${q}_{1 - ϵ}^{r} = {s}_{⌈ ( 1 - ϵ ) \cdot ( r + 1 ) ]} \qquad ( 9 )$$

Adaptive Stopping Criteria: Adaptive stopping may be achieved by monitoring the variation of the conformal prediction quantile. After r samples, the (1−ϵ)-quantile may be recomputed and compared with the one from r−1 samples. The sampling process may stop when the quantile satisfies:

$$\vert \begin{matrix}{q}_{1 - ϵ}^{r} - {q}_{1 - ϵ}^{r - 1} \vert \leq ξ & ( 10 ) )\end{matrix}$$

For a given sampling deviation threshold ξ and a scale τ, the sample amount τ should satisfy:

$$τ ( \frac{1}{\sqrt{r - 1}} - \frac{1}{r} ) \leq ξ \qquad ( 11 )$$

This proposition may offer an estimation of the sample amount under the threshold ξ.

Error Rate with Adaptive Stopping: Under the sampling threshold ξ, the majority voting error rate of the mixture distribution may become:

$$( 1 - min ( ξ , \frac{τ}{\sqrt{r}} ) ) {\tilde{P}}_{BB} < {\tilde{P}}_{adapt} < ( 1 + min ( ξ , \frac{τ}{\sqrt{r}} ) ) {\tilde{P}}_{BB} \qquad ( 12 )$$

This proposition may provide a theoretical error bound for estimation under adaptive stopping, suggesting the mild degradation of estimation performance.

In sampled experiments, ξ=0.03, and τ=25, may lead to r≥56.

To further improve the data efficiency when only a few samples are available and enhance estimation accuracy, the present method may incorporate prior knowledge about the LLM ensemble on other open-source datasets and transfer the estimated judgment distributions to the target dataset. However, one challenge is that the prior transfer may bring performance degradation if the distributions of the source datasets and the target dataset are very different. To resolve this challenge, the present method may design text similarity-based distribution prior transfer, which may leverage the strong text embedding capability of the recent models to understand and measure the textual difference among datasets.

Text Embedding: To embed the text inputs of the LLM ensemble, NV-Embed-V2 may be used. Given sets of samples {D₁, D₂, . . . , Dₘ} from m source datasets, the embedding model ε(⋅) may be utilized to transform the sets of samples to sets of embeddings for the source datasets:

{E₁,E₂, . . . ,Eₘ}={ε(D₁),ε(D₂), . . . ,ε(Dₘ)} (13)

The average embedding

$${\overline{E}}_{ι} = \frac{1}{{r}_{i}} {\sum }_{j = 1}^{{r}_{i}} {E}_{i}^{j}$$

of the i-th dataset may be used to represent it.

Distribution Prior Transfer: To transfer the distribution from source datasets to the target dataset D₀, the process may start by embedding the target dataset D₀=ε(D₀) and acquiring its average embedding E̅₀̅. For the dataset Dᵢ, its transfer weight may be defined as:

λᵢ=log(rᵢ)·σ(10·(CosSim(E̅₀̅,E̅₁̅)−0.9)) (14)

where σ(⋅) may be the sigmoid function and rᵢ may be the number of samples. This design may be adopted to avoid the degradation of estimation caused by transferring datasets with dissimilar text inputs. This may be achieved by setting a threshold and applying the sigmoid function to suppress the weight when the similarity is low. log rᵢ may be included as datasets with more samples may produce a more accurate estimation and thus should have a higher impact on the transfer. Taking the transferred parameters ω₀^{tr} and

$${α}_{0 , j}^{tr}$$

as an example:

$${ω}_{0}^{tr} = \frac{{\sum }_{i = 0}^{m} {λ}_{i} \cdot {ω}_{i}}{{\sum }_{i = 0}^{m} {λ}_{i}} , {α}_{0 , j}^{tr} = \frac{{\sum }_{i = 0}^{m} {λ}_{i} \cdot {∝}_{i , j}}{{\sum }_{i = 0}^{m} {λ}_{i}} , j ∈ \{ 1 , 2 \} \qquad ( 15 )$$

In Equation (15), ∝_{i,j} may be the j-th parameter in the mixture distribution of i-th dataset. The parameters in the weighted sum with index 0 may denote direct estimation using the limited samples of the target dataset.

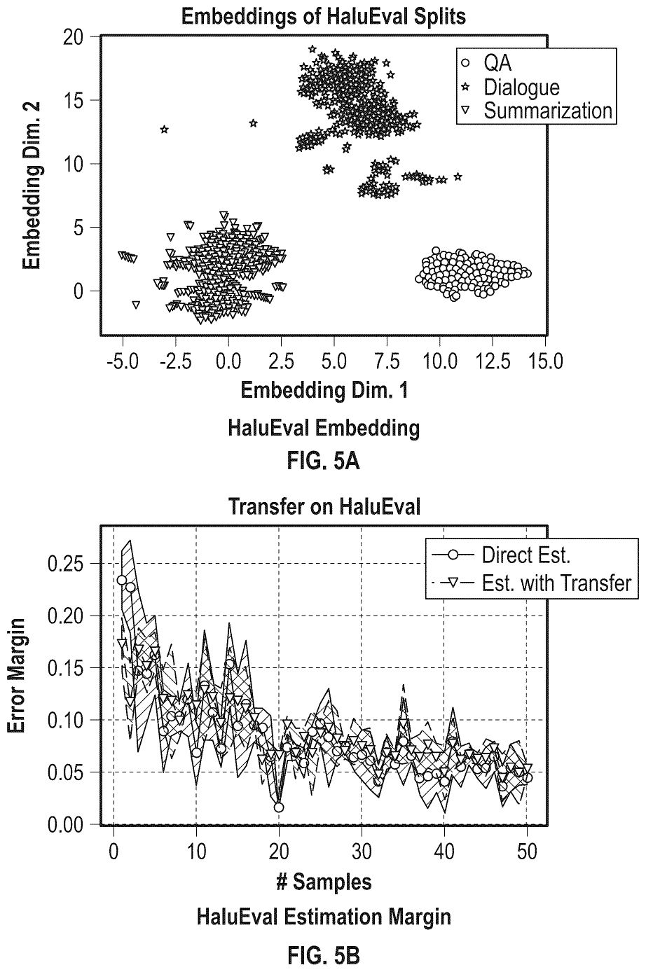

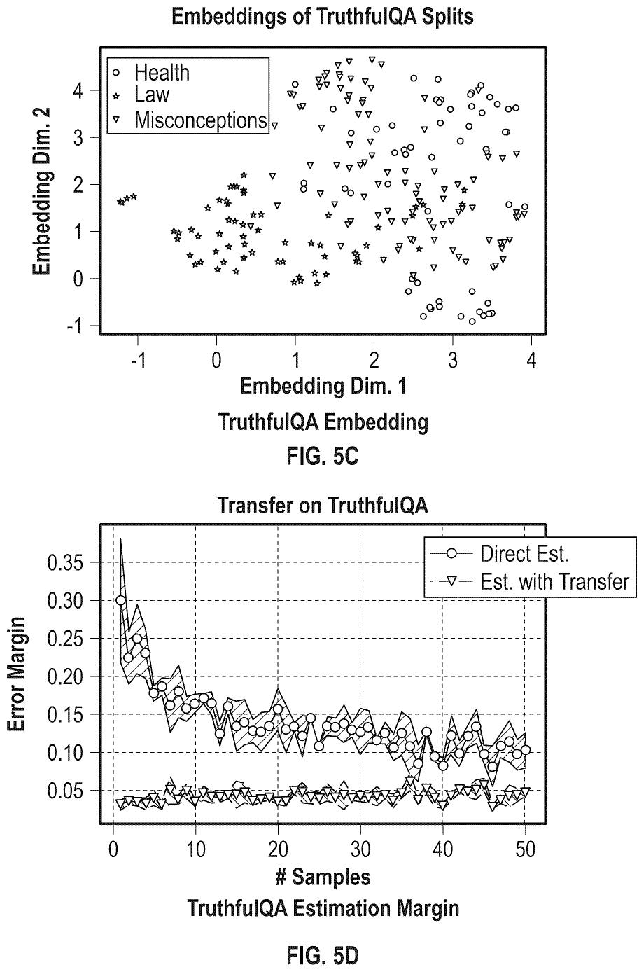

To verify the distribution design, the distribution may be evaluated within splits of HaluEval and TruthfulQA datasets. For HaluEval, Dialogue and Summarization splits may be used as source datasets and transfer to QA split; for TruthfulQA, the design may transfer from topics of Health and Law to Misconceptions. As shown in FIG. 5, the embeddings may form distant clusters in HaluEval, as the text inputs of the three splits have different hallucination detection requirements, and embeddings from TruthfulQA may overlap due to the similarity of judgment format. When clusters are separated, the present method may not bring performance degradation compared to solely using samples from the target dataset, while when clusters are overlapping, the present method may bring a significantly lower estimation error rate margin compared to only using target dataset samples. This may support the effectiveness of our distribution transfer design.

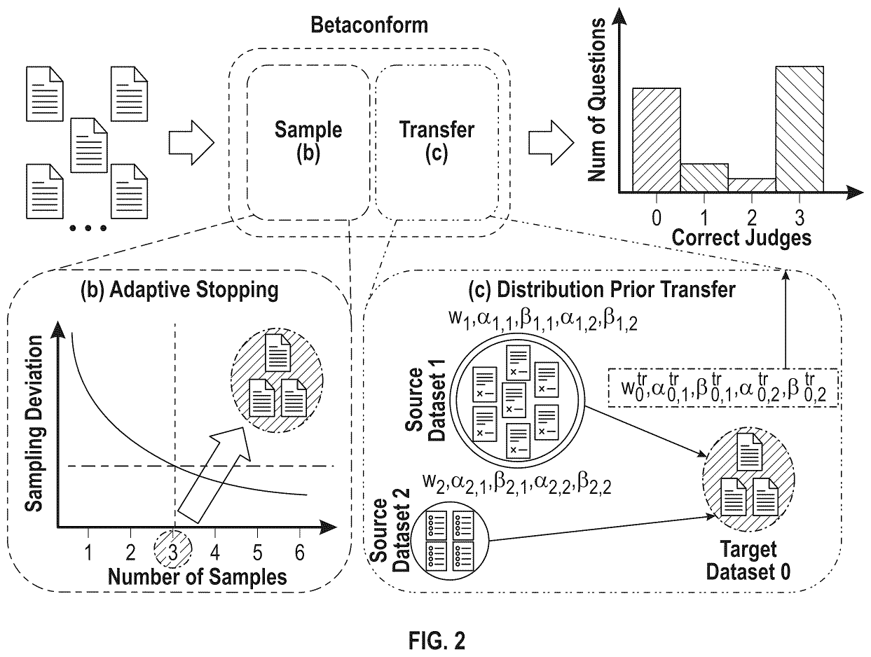

BetaConform: BetaConform is a framework that may provide efficient estimation of judgment distribution, as shown in FIG. 2 and Methodology 1. When only limited samples on the target dataset are available, it may transfer distribution priors from source datasets. Given more samples, it may employ adaptive stopping during iterative sampling to balance sample efficiency with estimation accuracy.

### BetaConform Methodology

```
  1: Input: target dataset D₀, source datasets D₁, ... , Dₘ,
          judges [symbol]  = {J₁, ... , Jₖ}, EM algorithm EM(·)
  2: Output: distribution parameters Ω on the target dataset
  3: If limited samples in D₀ then
  4: Compute distribution parameters on D₀
  5: Compute parameters of distributions on D₁, ... Dₘ
  6: Compute transfer weights by Equation (14)
  7: Ω ← Compute transferred parameters by Eq, (15)
  8: else
  $9 : Initial D ← \{ \} , q \text{?} ← - ∞$
10: while Equation (10) is not satisfied do
$11 : Add a sample from {D}_{0} to D and update q \text{?}$
12: end while
13: Ω ← Compute distribution parameters on samples D
14: end if
15: return Ω
$\text{?} \text{indicates text missing or illegible when filed}$
```

LLM ensembles of up to 11 models may be evaluated, including popular close-source models and open-source models. Domains of hallucination detection, reasoning, scoring and alignment may be chosen. Across experiments, the adaptive stopping threshold may be set to ξ=0.01, which may require at least r≥51 samples to meet the stopping criteria. The sampling and estimation process may be conducted 30 times on each dataset.

Evaluating BetaConform may begin with adaptive stopping on datasets to verify its accuracy. Binomial distribution may be chosen as the baseline and compare the error margin, which may be the absolute difference between the estimation error rate and the actual value. The results of the error margin and sample numbers may be shown in Table 1 below.

From the results, the following observations may be drawn: [symbol] Compared to the binomial distribution, BetaConform may achieve consistently lower error margin, with 32.4%~54.1% improvements of average error margin of all models. This may demonstrate an effective answer to RQ1 by modeling judgment distribution as a mixture of beta-binomail distributions. [symbol] The number of samples may be close to the theoretical estimation. The average sample amount of models on all datasets may exhibit a slight deviation of the estimated value 56 by 3.14~12.86 samples. This may validate the present design of using the distribution-free OP for adaptive stopping, which may effectively solve RQ2.

TABLE 1
The comparison of error margins berween our mixture of Beta-Binomial distributions and Binomial distribution. The [symbol]
Margin and # Samples answer RO1 and RQ2, respectively. The error margin is calculated as the absolute difference between the actual
error rate and the estimation. Estimations using both distributions are done on samples obtained through iterative sampling with adaptive
stopping. For each run, the error margin is computed from k = 1 to 11, and the average margin of ensemble sizes is used as the result for
that run. We conduct 30 runs and report the average and standard deviation. The average number of samples across runs is also reported.

| | | [symbol] | | [symbol] | | [symbol] | | [symbol] | | [symbol] | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |

[symbol]

| | | | | | | | | | | | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |

[symbol]

| | | | | | | | | | | | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |

[symbol]

| | | | | | | | | | | | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |

[symbol]

| | | | | | | | | | | | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |

[symbol]

| | | | | | | | | | | | |
|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] |
| | [symbol] | [symbol] | | [symbol] | | [symbol] | | [symbol] | | [symbol] | |

[symbol]

indicates data missing or illegible when filed

The text similarity-based distribution prior transfer when only limited samples are available may then be verified. It may be constrained to 10 samples from the target dataset and assume the full source datasets may be accessible. Transfer may be compared with estimating only on the target dataset samples (w/o Transfer). Error margins may be shown in Table 2 below.

From the results, it may be observe that by transferring from other datasets in the same category, the average error margin across all datasets may be reduced by 5.0%~25.0% and may be consistently lower compared to no transfer, suggesting the effectiveness of the present design that using prior knowledge of the judgment distributions on open-source datasets can benefit estimation.

TABLE 2
The comparison of error margins with and without distribution prior transfer. Estimations are performed using the mixture of
Beta-Binomial distributions, with 10 samples randomly drawn for evaluation. In experiments, each dataset is chosen as the target dataset,
and the left datasets la the same domain are used as source datasets.

| | | | | | | |
|---|---|---|---|---|---|---|
| Dataset | Method | [symbol] | [symbol] | [symbol] | [symbol] | GPT-4 |

Hallucination Detection Datasets

| | | | | | | |
|---|---|---|---|---|---|---|
| [symbol] | w/o Transfer | [symbol] | [symbol] | [symbol] | [symbol] | [symbol] |
| | w/ Transfer | [symbol] | [symbol] | [symbol] | [symbol] | [symbol] |
| [symbol] | w/o Transfer | [symbol] | [symbol] | [symbol] | [symbol] | [symbol] |
| | w/ Transfer | [symbol] | [symbol] | [symbol] | [symbol] | [symbol] |
| [symbol] | w/o Transfer | [symbol] | [symbol] | [symbol] | [symbol] | [symbol] |
| | w/ Transfer | [symbol] | [symbol] | [symbol] | [symbol] | [symbol] |

Reassessing Datasets

| | | | | | | |
|---|---|---|---|---|---|---|
| [symbol] | w/o Transfer | [symbol] | [symbol] | [symbol] | [symbol] | [symbol] |
| | w/ Transfer | [symbol] | [symbol] | [symbol] | [symbol] | [symbol] |
| [symbol] | w/o Transfer | [symbol] | [symbol] | [symbol] | [symbol] | [symbol] |
| | w/ Transfer | [symbol] | [symbol] | [symbol] | [symbol] | [symbol] |
| TRAM | w/o Transfer | [symbol] | [symbol] | [symbol] | [symbol] | [symbol] |
| | w/ Transfer | [symbol] | [symbol] | [symbol] | [symbol] | [symbol] |

[symbol]

Datasets

| | | | | | | |
|---|---|---|---|---|---|---|
| [symbol] | w/o Transfer | [symbol] | [symbol] | [symbol] | [symbol] | [symbol] |
| | w/ Transfer | [symbol] | [symbol] | [symbol] | [symbol] | [symbol] |
| [symbol] | w/o Transfer | [symbol] | [symbol] | [symbol] | [symbol] | [symbol] |
| | w/ Transfer | [symbol] | [symbol] | [symbol] | [symbol] | [symbol] |
| [symbol] | w/o Transfer | [symbol] | [symbol] | [symbol] | [symbol] | [symbol] |
| | w/ Transfer | [symbol] | [symbol] | [symbol] | [symbol] | [symbol] |

[symbol]

Datasets

| | | | | | | |
|---|---|---|---|---|---|---|
| ICE- [symbol] | w/o Transfer | [symbol] | [symbol] | [symbol] | [symbol] | [symbol] |
| | w/ Transfer | [symbol] | [symbol] | [symbol] | [symbol] | [symbol] |
| COMP-Analysis | w/o Transfer | [symbol] | [symbol] | [symbol] | [symbol] | [symbol] |
| | w/ Transfer | [symbol] | [symbol] | [symbol] | [symbol] | [symbol] |

Average

| | | | | | | |
|---|---|---|---|---|---|---|
| Average | w/o Transfer | [symbol] | [symbol] | [symbol] | [symbol] | [symbol] |
| | w/ Transfer | [symbol] | [symbol] | [symbol] | [symbol] | [symbol] |

Bold numbers denote lower mean margin. Scores are in porcent (%). [symbol]
indicates data missing or illegible when filed

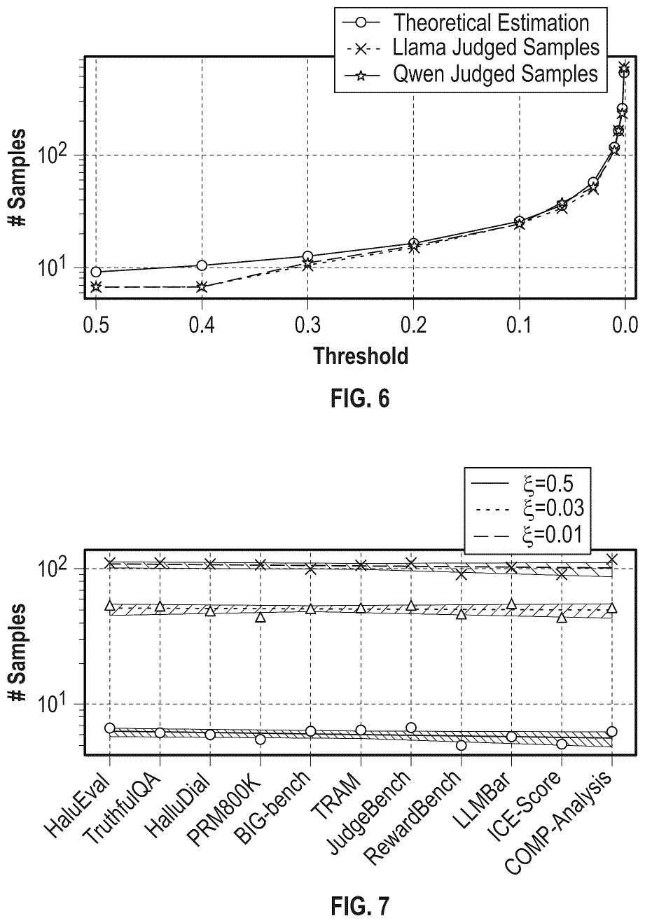

The adaptive stopping may be examined to see if Equation (11) may match the real sampling amount. A series of ξ may be set while keeping τ=25 and sampled with adaptive stopping from judgment samples produced by Llama, Qwen, and GPT-4, and compared with the theoretical value of Equation (11). The actual sample amounts under different thresholds in FIG. 6 may match closely with the theoretical estimation, which may prove the effectiveness of quantifying sampling deviation through CP and the above proposition.

One benefit of adopting CP to quantify sampling deviation may be distribution irrelevance. To testify to this, sampling with various thresholds on all datasets may be considered to see if the sample amount remains consistent. The results in FIG. 7 may show only a slight variance of sampling amounts across datasets, which may demonstrate stability. This may verify that the present adaptive stopping may be truly distribution-free, offering identical sampling guidance on diverse datasets.

To validate the effectiveness of the present CP-based adaptive stopping, it may be compared against variance-based stopping. Specifically, the variance of sampling may be calculated as:

$$Var ( sampling ) = \frac{{α}_{r} {β}_{r}}{{( {a}_{r} + {β}_{r} )}^{2} ( {a}_{r} + {β}_{r} + 1 )} \qquad ( 16 )$$

where αᵣ may be the number of correct judgments in r samples, and βᵣ=r−αᵣ may be the number of wrong samples.

As shown in Table 3 below, CP may consistently provide more effective guidance for adaptive stopping under the same deviation threshold ξ, which may result in a reduced number of samples and may achieve a reduction of up to 46.3%.

TABLE 3
Comparison of variance-based adaptive stopping and our
CP stopping. We compare the sample amount of both methods
under the same threshold.

| | | HaluEval | Judge Bench | PRM800K | ICE-Score |
|---|---|---|---|---|---|
| Threshold ξ | Methods | # Samples (J) | # Samples (J) | # Samples (J) | # Samples (J) |
| ξ = 0.06 | Variance | 36.87 | 36.87 | 26.00 | 24.77 |
| | Ours | 35.37 | 36.37 | 30.47 | 31.53 |
| ξ = 0.03 | Variance | 82.09 | 74.43 | 79.76 | 81.47 |
| | Ours | 54.72 | 53.90 | 43.32 | 45.27 |
| ξ = 0.01 | Variance | 194.72 | 198.36 | 147.22 | 151.44 |
| | Ours | 109.06 | 106.56 | 101.28 | 96.50 |

Bold denotes less samples.

A framework, BetaConform, may be presented for efficient estimation of LLM ensemble judge distribution. As part of the framework, a mixture of beta-binomial distributions may be proposed to model the judgment distribution after examining the inaccuracy of the binomial assumption. Conformal prediction-based adaptive stopping for sampling may be designed, which may monitor the sampling deviation and may effectively determine the sample amount for estimation. When only limited samples are available, a text similarity-based distribution prior transfer mechanism may be provided to improve the estimation accuracy. As shown by experiments, the conformal prediction-based adaptive stopping may effectively guide the sampling. The present mixture of beta-binomial distributions may significantly outperform the common binomial assumption. With the transfer mechanism, BetaConform may achieve high estimation precision with as few as 10 samples.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1-20. (canceled)

21. A method for maximum a posteriori (MAP) estimations of large language model (LLM) ensemble judgment performance, comprising:
modeling a judgement distribution as a mixture of beta-binomial distributions to reflect stratification;
using conformal prediction to enables adaptive stopping during iterative sampling when a sampling deviation is below a threshold value; and
using a prior transfer mechanism that utilizes learned distributions on open-source datasets to improve estimation on a target dataset when only annotations below a threshold value are available.

22. The method of claim 21, wherein modeling a judgement distribution as a mixture of beta-binomial distributions comprises modeling the judgement distribution as a mixture of two beta-binomial distributions, wherein a first beta-binomial distribution models a first set of LLM ensemble judgments on straightforward questions and a second beta-binomial distribution models a second set of LLM ensemble judgments for hard problems having at least one of multiple steps and multiple constraints.

23. The method of claim 21, comprising optimizing the mixture of beta-binomial distributions through expectation maximization (EM).

24. The method of claim 23, wherein optimizing the mixture of beta-binomial distributions through EM comprises sampling judgments of the beta-binomial judgement distributions, wherein parameters are updated based on weighted contributions of the samples taken.

25. The method of claim 21, wherein using conformal prediction dynamically evaluates the sampling deviation in a distribution of a number of correct judgments in the judgement distribution.

26. The method of claim 21, wherein using conformal prediction comprises
calculating a nonconformity score that measures how a test sample differs from a remainder of the judgement distribution; and
monitoring a variation of the conformal prediction quantile, wherein a sampling process stops when the conformal prediction quantile is below the threshold value.

27. The method of claim 12, wherein using a prior transfer mechanism comprises:
embedding text inputs from both source and target datasets; and
calculating embedding similarities to determine a transfer weight.

28. The method of claim 27, comprising applying a sigmoid function to suppress the transfer weight when a similarity is below a predefined value.

29. A method for maximum a posteriori (MAP) estimations of large language model (LLM) ensemble judgment performance, the method implemented using a computer system including a processor communicatively coupled to a memory device, the method comprising:
modeling a judgement distribution as a mixture of two beta-binomial distributions, wherein a first beta-binomial distribution models a first set of LLM ensemble judgments on straightforward questions and a second beta-binomial distribution models a second set of LLM ensemble judgments for hard problems having at least one of multiple steps and multiple constraints;
optimizing the mixture of the two beta-binomial distributions through expectation maximization (EM);
using conformal prediction to enable adaptive stopping during iterative sampling when a sampling deviation is below a threshold value; and
using a prior transfer mechanism that utilizes learned distributions on open-source datasets to improve estimation on a target dataset when only annotations below a threshold value are available.

30. The method of claim 29, wherein optimizing the mixture of two beta-binomial distributions through EM comprises sampling judgments of the two beta-binomial distributions, wherein parameters are updated based on weighted contributions of the samples taken.

31. The method of claim 29, wherein using conformal prediction dynamically evaluates the sampling deviation in a distribution of a number of correct judgments in the judgement distribution.

32. The method of claim 29, wherein using conformal prediction comprises
calculating a nonconformity score that measures how a test sample differs from a remainder of the judgement distribution; and
monitoring a variation of the conformal prediction quantile, wherein a sampling process stops when the conformal prediction quantile is below the threshold value.

33. The method of claim 29, wherein using a prior transfer mechanism comprises:
embedding text inputs from both source and target datasets; and
calculating embedding similarities to determine a transfer weight.

34. The method of claim 33, comprising applying a sigmoid function to suppress the transfer weight when a similarity is below a predefined value.

35. A method for maximum a posteriori (MAP) estimations of large language model (LLM) ensemble judgment performance, comprising:
modeling a judgement distribution as a mixture of beta-binomial distributions;
optimizing the mixture of beta-binomial distributions through expectation maximization (EM);
using conformal prediction to enable adaptive stopping during iterative sampling when a sampling deviation is below a threshold value, wherein using conformal prediction dynamically evaluates the sampling deviation in a distribution of a number of correct judgments in the judgement distribution; and
using a prior transfer mechanism that utilizes learned distributions on open-source datasets to improve estimation on a target dataset when only annotations below a threshold value are available.

36. The method of claim 35, wherein modeling a judgement distribution as a mixture of beta-binomial distributions comprises modeling the judgement distribution as a mixture of two beta-binomial distributions, wherein a first beta-binomial distribution models a first set of LLM ensemble judgments on straightforward questions and a second beta-binomial distribution models a second set of LLM ensemble judgments for hard problems having at least one of multiple steps and multiple constraints.

37. The method of claim 35, wherein optimizing the mixture of beta-binomial distributions through EM comprises sampling judgments of the beta-binomial judgement distributions, wherein parameters are updated based on weighted contributions of the samples taken.

38. The method of claim 35, wherein using conformal prediction comprises
calculating a nonconformity score that measures how a test sample differs from a remainder of the judgement distribution; and
monitoring a variation of the conformal prediction quantile, wherein a sampling process stops when the conformal prediction quantile is below the threshold value.

39. The method of claim 35, wherein using a prior transfer mechanism comprises:
embedding text inputs from both source and target datasets; and
calculating embedding similarities to determine a transfer weight.

40. The method of claim 39, comprising applying a sigmoid function to suppress the transfer weight when a similarity is below a predefined value.
